(19) United States
(12) Patent Application Publication
(10) Pub. No.: US 2025/0292014 A1
(43) Pub. Date: Sep. 18, 2025

(54) FRAMEWORK FOR EMBEDDING GENERATIVE AI INTO ERP SYSTEMS

(71) Applicant: SAP SE, Walldorf (DE)

(72) Inventor: Siar Sarferaz, Heidelberg (DE)

(73) Assignee: SAP SE, Walldorf (DE)

(21) Appl. No.: 18/602,683

(22) Filed: Mar. 12, 2024

(51) Int. Cl. G06F 40/20; G06Q 10/067

(52) U.S. Cl. CPC G06F 40/20; G06Q 10/067

(57) ABSTRACT

A computer-implemented method can run an application associated with an intelligent scenario deployed on an enterprise resource planning (ERP) system. The application receives input values for one or more parameters from a tenant user through a user interface of the ERP system. The method can select a prompt template defined in the intelligent scenario, generate a prompt using the prompt template by replacing the one or more parameters included in the prompt template with respective input values, prompt a large language model (LLM) specified by the intelligent scenario using the prompt, receive a response generated by the LLM, and present the response on the user interface of the ERP system.

### BACKGROUND

Enterprise resource planning (ERP) is software that allows an organization to use a system of integrated applications to manage their business and automate many back-office functions related to technology, services and human resources. Some ERP systems, such as S/4HANA provided by SAP SE, of Walldorf, Germany, offer artificial intelligence (AI) solutions to add value to customers. Integration of AI in ERP systems can potentially enhance automation, data analysis, and decision-making. Recent advancements in generative AI, such as large language models (LLMs), offer exciting new possibilities for ERP systems. By leveraging generative AI, organizations can enhance data analytics, predict future scenarios, and customize user experiences. However, embedding generative AI in existing ERP systems presents unique challenges not encountered with classic AI solutions, such as standardized implementation, lifecycle management, scalability and extensibility, security compliance, etc. Thus, room for improvement exists for embedding generative AI in ERP systems.

### BRIEF DESCRIPTION OF THE DRAWINGS

FIG. 1 is an overall block diagram of an example computing system including a framework for embedding generative AI into an ERP system.

FIG. 2 is a block diagram depicting different phases for lifecycle management of a generative AI scenario.

FIG. 3 is an architecture diagram of an example large language model.

FIG. 4 is a flowchart illustrating an example overall method for improved generative AI support for an ERP system.

FIG. 5 is a sequence diagram illustrating example operations involved when running a generative AI application embedded on an ERP system.

FIG. 6 depicts an example user interface for generating a prompt template.

FIG. 7 depicts an example metamodel for a generative AI scenario.

FIG. 8 is a block diagram depicting an example system architecture supporting shared LLM access service for an ERP system.

FIG. 9 is a block diagram depicting an example system architecture supporting prompt lifecycle management.

FIG. 10 is a block diagram of an example computing system in which described embodiments can be implemented.

FIG. 11 is a block diagram of an example cloud computing environment that can be used in conjunction with the technologies described herein.

### DETAILED DESCRIPTION

### Overview of Generative AI in ERP Systems

Generative AI holds immense potential to revolutionize the way AI is utilized in various sectors, including ERP systems. By harnessing the power of advanced models, businesses can streamline their processes, enhance decision-making, and automate repetitive tasks, driving growth and innovation. Non-technical users can leverage these capabilities simply by describing their business tasks in natural language, eliminating the need for extensive technical expertise.

In the context of ERP systems, generative AI can significantly improve the user experience and boost productivity. For example, generative AI enables users to interact with the system using natural language, making it easier to navigate and access required functionalities. This can lead to efficient retrieval of information and a more enjoyable user experience. Automation in customer support can expedite issue resolution and enhance satisfaction levels. Generative AI can also assist in content creation and knowledge management, generating or improving various types of content, such as marketing and sales copies. This makes it easier for businesses to communicate their value proposition to their customers. Additionally, generative AI can summarize complex ERP documents and data, enabling users to quickly understand key points and make informed decisions. For developers working with ERP systems, features such as code generation from natural language and code auto-completion can increase efficiency and reduce time-to-market for new features or improvements. Automated generation of documentation ensures access to accurate and up-to-date information, further streamlining the development process.

Despite the immense potentials of generative AI, its implementation in ERP systems currently faces several challenges. The implementation is largely ad hoc and not standardized within a unified framework. As a result, generative AI solutions in ERP systems often vary in design and approach, leading to inconsistent quality due to differing software development methodologies among developers. For customers of ERP systems, the configuration and operations are often nonuniform, but are dependent on how the generative AI solutions are implemented. Some important features, such as error handling, result validation, legal compliance, and prompt auditing, may not be uniformly presented in all generative AI solutions.

Additionally, the constant evolution of generative AI necessitates that implemented solutions be adaptive to accommodate new products and versions from various vendors. Without this adaptability, the performance of generative AI solutions may degrade over time. The lack of a standardized framework often leads to developers reinventing the wheel, even when some features of one AI solution could be leveraged and reused for another AI solution. The absence of a standardized framework also complicates the lifecycle management of generative AI solutions, including their design, deployment, monitoring, evaluation, updating, and retirement. This lack of standardization also makes data integration difficult in ERP systems, presenting another challenge in the effective implementation of generative AI.

The technologies described herein address many of the challenges previously mentioned by introducing a standardized framework for integrating generative AI into ERP systems. This framework employs techniques such as prompt engineering, embeddings, and fine-tuning. Prompt engineering involves crafting specific tasks or questions in natural language, guiding the generative AI models to generate more accurate and relevant responses. Embeddings represent domain-specific knowledge in a numerical format that the generative AI models can easily process and learn from, thereby enhancing their understanding of the domain and their ability to generate context-aware outputs. Fine-tuning involves adapting the generative AI models using a small set of task-specific labeled data, enabling them to learn the nuances of the task and improve their performance. By combining these techniques, the framework can adapt the generative AI models to a wide range of tasks and domains within ERP systems, enhancing their performance to meet specific needs.

### Example Computing System Including a Framework for Embedding Generative AI in ERP Systems

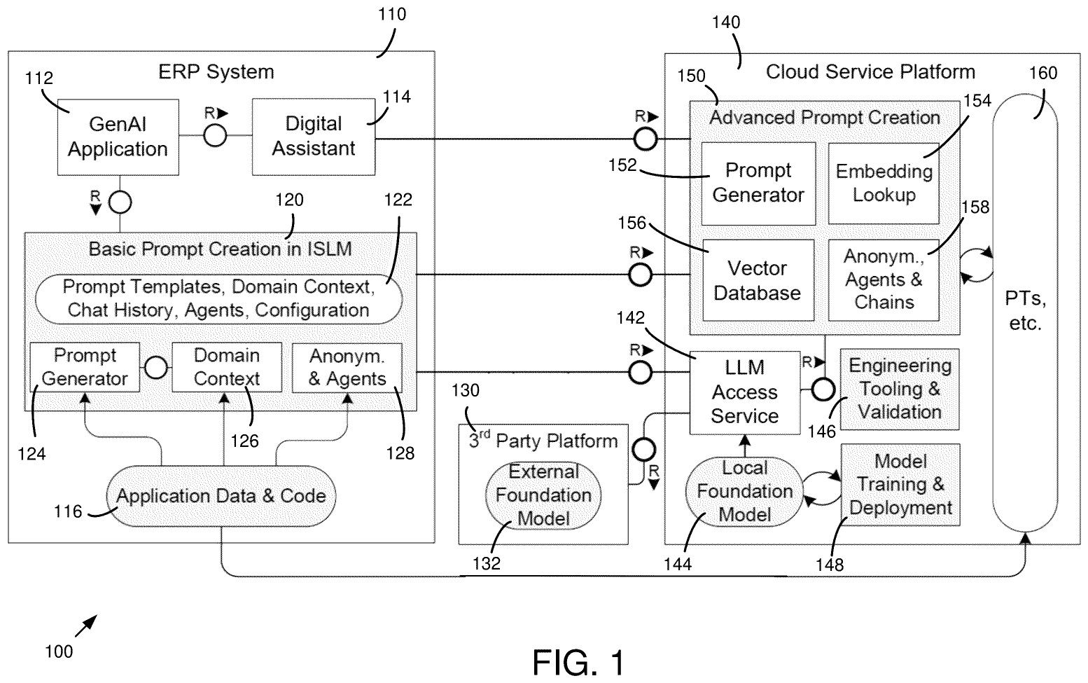

FIG. 1 shows an overall block diagram of an example computing system 100 with a framework for embedding generative AI in ERP systems.

In the depicted example, the computing system 100 includes an ERP system 110 in communication with a cloud service platform 140. The ERP system 110 can be cloud-based (e.g., SAP S/4HANA), allowing organizations to access it over the internet. The ERP system 110 integrates and automates a multitude of financial and operational business functions and provides a single source of data, including inventory, order, and supply chain management. The ERP system 110 can be configured to support multi-tenancy so that applications of the ERP system 110 can be deployed on each tenant's computing system. The cloud service platform 140 provides a set of tools and products that enable integration and extension of all applications and data assets communicating with the cloud service platform 140. For example, an example cloud service platform 140 can be Business Technology Platform (BTP), provided by SAP SE, of Walldorf, Germany, which brings together application development and automation, data and analytics, integration, and AI capabilities in one unified environment. As described herein, the cloud service platform 140 provides access to one or more generative AI models, which can be hosted externally or deployed on the cloud service platform 140.

The ERP system 110 can run a generative AI application 112 (also referred to as a GenAI application). The generative AI application 112 can communicate with a digital assistant 114 and a prompt engine 120. The digital assistant 114 can be configured to receive queries or prompts in natural language from a user of the generative AI application 112 and submit the user's queries or prompts to a generative AI model via the cloud service platform 140. The response generated by the generative AI model can be received by the digital assistant 114 and returned to the user. Thus, the digital assistant 114 can act as a chatbot and handle question-and-answer use cases.

The prompt engine 120 is configured to handle dynamic prompt creation functionalities using an intelligent scenario lifecycle management (ISLM) framework. The ISLM framework is configured to perform lifecycle management of the AI solutions, also referred to as intelligent scenarios. As described herein, an intelligent scenario utilizing generative AI models can also be referred to as a generative AI scenario. A generative AI application (e.g., the generative AI application 112) can consume a corresponding generative AI scenario.

As described herein, an intelligent scenario is a representation of an AI or machine learning (ML) driven business use case for integration in an ERP system. The intelligent scenarios can be implemented using appropriate programming languages (e.g., the ABAP language developed by SAP) that suits the environment. Each intelligent scenario entails applying AI/ML techniques to address specific business needs while tailoring the solution to the organization's unique requirements. The AI/ML functionality of each intelligent scenario is translated into code, allowing smooth integration and execution within an ERP system, aligning the AI/ML capabilities with the organization's business objectives. For example, one example intelligent scenario can be configured to perform demand forecasting by using historical sales data and market trends to predict future demand; another example intelligent scenario can be configured to assess supplier performance based on factors like delivery times and quality to make informed sourcing decisions; and so on.

For dynamic prompt creation, a user can enter input parameter values through a user interface provided by the generative AI application 112. The input parameter values entered by the user can be combined with selected prompt templates to generate corresponding prompts, which are submitted to a generative AI model via the cloud service platform 140. The response generated by the generative AI model can be presented to the user through the user interface. As described herein, a prompt template is a predefined text structure with parameters or placeholders that can be replaced with different values, guiding a generative AI model to generate specific types of responses or content.

In the depicted example, the prompt engine 120 includes a data storage 122 which stores prompt templates, domain context, chat history, configuration information, etc. The prompt engine 120 also includes a prompt generator 124, a domain context handler 126, and a prompt handler 128.

The prompt generator 124 is configured to generate one or more prompts based on the user's input. Specifically, the generative AI application 112 can receive user entered input values for one or more parameters from a tenant user through a user interface of the ERP system 110. The generative AI application 112 can have a predefined prompt template (in the data storage 122) which includes the one or more parameters. The prompt generator 124 can generate, in runtime, a prompt using the prompt template by replacing the one or more parameters in the prompt template with respective input values.

In the depicted example, the domain context handler 126 is configured to retrieve domain context for parameters in a prompt template. As described herein, domain context refers to the problem space or the business domain that the generative AI application 112 is designed to address. The domain context handler 126 ensures that the right context is provided for each parameter. This is important because each tenant of the ERP system 110 has its own database, and the same parameter may be defined in different database tables for different tenants. The acceptable input values for a parameter may also be different for different tenants, and the domain context handler 126 ensures that the relevant information for input values of a parameter is specific to a tenant's database.

The domain context is specific to a tenant of the ERP system 110 and includes metadata that defines parameters in the tenant's database. For example, the parameters in the prompt template can represent fields in the database tables of a specific tenant. The domain context handler 126 can retrieve the domain context by invoking specific method calls pertinent to the parameters. For example, for each parameter in the prompt template, a corresponding method call can retrieve metadata, such as identifier (ID), description, default value, data type, and other information of a corresponding field in the tenant's database tables. Because the domain context can provide contextual information pertinent to the template parameters, the domain context can be sent to the generative AI model along with the created prompt. This can enhance the relevance and accuracy of the model-generated responses, reduce ambiguity, and improve the model's understanding of the specific domain, thereby leading to more precise and contextually appropriate responses.

In some examples, the domain context handler 126 can be configured to ensure that parameter values entered by the user through the user interface are values of corresponding attributes stored in those database tables so that the parameter values can be understood and accepted by the application. For instance, a “country” parameter in a prompt template may accept predefined country codes defined in a database table, and the user input values need to be selected from those predefined country codes. In some examples, after a prompt is generated based on the prompt template by replacing the parameters with the user-entered input values for the parameters, the prompt can be sent to a generative AI model to generate a response. When processing (e.g., saving) the response in the tenant's ERP system 110, the values of the parameters need to be processed by using acceptable codes in database tables (e.g., predefined “country” code instead of country name).

In the depicted example, the prompt handler 128 is configured to process the generated prompt and send it to a selected generative AI model to elicit a response. In some examples, the prompt handler 128 can be configured to anonymize the prompt before submitting the prompt to the generative AI model and then deanonymize the response generated by the generative AI model. Prompt anonymization can help protect sensitive user data. By anonymizing the prompt before submitting it to the generative AI model, the prompt handler 128 ensures that any sensitive information is not exposed, thereby maintaining the privacy and confidentiality of the user's data. This is particularly important in adhering to data protection regulations and standards, such as GDPR and CCPA.

In some examples, the generative AI application 112 can cause the prompt generator 124 to generate multiple prompts, each based on a different prompt template. In such circumstances, the prompt handler 128 can instantiate multiple agents, each handling a different prompt. Specifically, the prompt handler 128 can be configured to coordinate operations of the agents so that the multiple prompts can be processed according to a desired sequence, that is, forming a prompt chain. For example, consider a scenario where the user is interacting with the ERP system 110 and wants to create a new product entry. The first prompt might be to ask for the product's name. Once the product's name is returned in a response from the generative AI model, it can be used to form the next prompt, which could be to ask for the product's price. The response to this prompt can then be used to form the next prompt, asking for the product's quantity in stock, and so on.

As shown in FIG. 1, the prompt engine 120 is connected to an application data and code repository 116, which stores application data and codes pertinent to the generative AI application 112, such as schema of ERP databases and code of local methods called by the prompt generator 124, the domain context handler 126, and the prompt handler 128. For example, the application data and code repository 116 can be a comprehensive storehouse of domain context data, which includes business rules, processes, policies, and entities that are pertinent to the problem space the generative AI application 112 is designed to tackle. The domain context data can also contain information that is needed for seamless operation of the generative AI application 112, such as the resources it leverages, its configuration settings, and the real-time status of its various components. In the context of the ERP system 110, the domain context data can encapsulate business rules governing procurement, inventory management, sales, finance, among other processes. It can also include technical details like database connections, user session data, and configuration settings. For example, if the ERP system 110 is tailored for a manufacturing company, the domain context data can include production schedules, inventory levels, details of raw material suppliers, product SKUs, customer orders, etc. All above domain context data can be retrieved by the domain context handler 126 and used for prompt processing by the prompt generator 124. The information which is data privacy relevant can be anonymized by the prompt handler 128 before sending to the generative AI model and after receiving the response de-anonymized accordingly.

In the depicted example, the cloud service platform 140 also includes a prompt engine 150 and a storage 160. Additionally, the cloud service platform 140 includes an access service layer 142, a local generative AI model 144, an engineering tool and validation unit 146, and a model training and deployment unit 148.

Like the storage 122, the storage 160 stores prompt templates (PTs), domain context, chat history, configuration information, etc. In the depicted example, the storage 160 is external to the prompt engine 150. In other examples, the storage 160 can be part of the prompt engine 150.

The prompt engine 150 can be configured to facilitate creation of more advanced prompts (compared to the prompt engine 120) to handle more sophisticated requirements concerning prompt engineering, such as prompts including embeddings. Leveraging external knowledge via embeddings can markedly enhance a generative AI model's capacity to assimilate domain-specific knowledge. Embeddings transmute information into a numerical format, thereby facilitating the model's learning process. The inclusion of domain-specific embeddings, such as exemplary code or product documentation, along with pre-trained embeddings from diverse sources, can augment the model's comprehension of the domain. For example, embeddings can equip the generative AI model with valuable references, enabling it to generate outputs that are not only more accurate but also contextually aware.

As shown in FIG. 1, the prompt engine 150 also includes a prompt generator 152 (similar to the prompt generator 124) configured to generate prompts based on a prompt template and user's input, and a prompt handler 158 (similar to the prompt handler 128) configured to process the prompts (e.g., anonymizing the prompts, sequencing the prompts in a prompt chain, etc.), and send the prompts to a generative AI model. Additionally, the prompt engine 150 can include an embedding engine 154 and a vector database 156.

The embedding engine 154 can be configured to embed domain-specific knowledge (e.g., exemplary code, product documentation, etc.) into vector representations, which are saved in the vector database 156. The embedding process involves transforming high-dimensional data into lower-dimensional vectors using various embedding techniques such as Word2Vec, GloVe, FastText, etc. These techniques capture semantic relationships between words or items based on their context or co-occurrence in a corpus. Further, the embedding engine 154 can be configured to search the vector database 156 to identify entities in the domain-specific knowledge matching the user's input. For example, the user's input can be embedded into a vector representation, which is compared to vector representations stored in the vector database 156. A similarity score (e.g., cosine similarity, etc.) can be calculated to measure similarity between two vectors.

The prompt engine 150 can provide context information for the prompts generated by the ERP system 110 (this holds true whether the prompts are directly inputted by the user via the digital assistant 114, or automatically generated based on prompt templates stored in either storage 122 or 160). Specifically, by transforming the user's input into vector representations and comparing it with the domain-specific knowledge embedded in the vector database 156, it can identify relevant entities and their semantic relationships. As a result, the prompts can be supplemented with contextually relevant information, thereby allowing the generative AI model to better understand the context of the user's input.

Both the prompt engines 120 and 150 are connected to generative AI models via the access service layer 142, which is configured to interface with different generative AI models, as described further below. The access service layer 142 can be connected to external generative AI models 132 hosted on a third-party platform 130, and/or local generative AI models 144 hosted on the cloud service platform 140.

In some examples, the cloud service platform 140 can have its own local generative AI models 144. Such local generative AI models 144 may be preferred than external generative AI models 132 for multiple reasons. For example, they may reduce latency by eliminating delays from cloud data transmission, enabling real-time responses. These local models may enhance privacy by keeping sensitive data under user control, simplifying compliance with regulations. Local models can also be fine-tuned for specific tasks, allowing customization and adaptability. In some examples, the local generative AI models 144 can be derived by training the highest layers of the external generative AI models 132 (developed by the third parties) with application specific data. Tools can be used to create, train, validate, and deploy local generative AI models 144. For example, the engineering tool and validation unit 146 can be used to design model architecture, prepare training data, test and validate the models, while the model training and deployment unit 148 can be used to train (and re-train), deploy, and monitor performance the models.

In practice, the systems shown herein, such as the computing system 100, can vary in complexity, with additional functionality, more complex components, and the like. For example, there can be additional functionality within the ERP system 110 and/or the cloud service platform 140. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, intelligent scenarios, prompt templates, prompts, domain context, and the like can be stored in one or more computer-readable storage media or computer-readable storage devices. The technologies described herein can be generic to the specifics of operating systems or hardware and can be applied in any variety of environments to take advantage of the described features.

### Example Lifecycle Management of Generative AI Scenario

As described above, the ISLM framework can perform lifecycle management of intelligent scenarios, including generative AI (GenAI) scenarios. Each generative AI scenario can include one or more software artifacts configured to interact with a generative AI model. For example, each generative AI scenario can define a method call to send a prompt (along with some prompt parameters) to a selected generative AI model and another method call to receive a response generated by the generated AI model. Additionally, each generative AI scenario can include metadata corresponding to the software artifacts and/or the generative AI model. For example, the metadata can include prompt templates and configuration parameters for the generative AI model, as described more fully below.

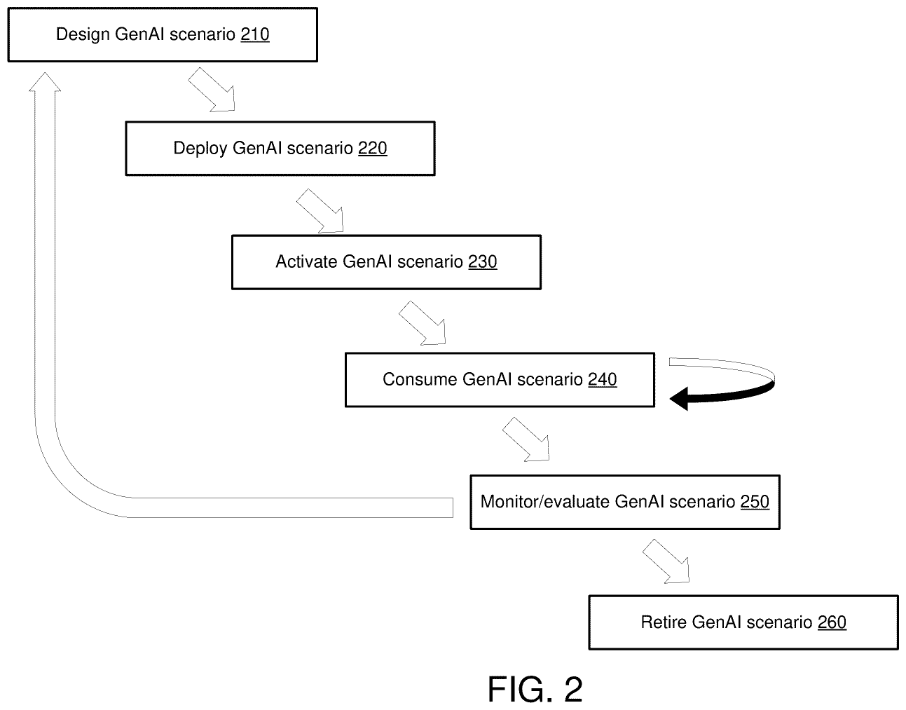

FIG. 2 illustrates different phases of lifecycle management of a generative AI scenario. The process initiates with the design phase 210, where specific AI/ML techniques are selected and tailored to meet the unique business needs. This phase involves creating software artifacts that interact with a designated generative AI model, which could be hosted on a third-party platform or the organization's own cloud service platform. Once the generative AI scenario is designed, the process moves to the deployment phase 220. Here, the generative AI scenario (including its associated software artifacts and metadata) is integrated into the ERP system. Tenant-specific configurations and/or authentication steps can be performed during the deployment phase 220. Following deployment, the generative AI scenario is activated in phase 230, making it ready for use or inference consumption. The consumption phase 240 then begins, where users actively use the deployed generative AI scenario. The usage can be repetitive, allowing for continuous utilization of the AI solution. The performance of the generative AI scenario is monitored and evaluated in phase 250. If it is detected that performance degrades over time, the ISLM can return to the design phase 210 for updates or improvements of the generative AI scenario. Finally, when the generative AI scenario is no longer needed (e.g., due to changes in business needs, availability of more advanced solutions, or other strategic decisions), it enters the retirement phase 260 when the generative AI scenario expires and can be deleted or archived. In sum, the lifecycle management ensures that the generative AI scenarios remain relevant, effective, and aligned with the organization's business objectives throughout their lifespan.

### Example Overview of LLMs and Prompts

Generative AI models, foundation models, and LLMs are interconnected concepts in the field of AI. Generative AI, a broad term, encompasses AI systems that generate content such as text, images, music, or code. Unlike discriminative AI models that aim to make decisions or predictions based on input data features, generative AI models focus on creating new data points. Foundation models are a subset of these generative AI models, serving as a starting point for developing more specialized models. LLMs, a specific type of generative AI, work with language and can understand and generate human-like text. In the context of generative AI, including LLMs, a prompt serves as an input or instruction that informs the AI of the desired content, context, or task. This allows users to guide the AI to produce tailored responses, explanations, or creative content based on the provided prompt.

In any of the examples herein, an LLM can take the form of an AI model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI, Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

In any of the examples herein, prompts can be provided, in runtime, to LLMs to generate responses. Prompts in LLMs can be input instructions that guide model behavior. Prompts can be textual cues, questions, or statements that users provide to elicit desired responses from the LLMs. Prompts can act as primers for the model's generative process. Sources of prompts can include user-generated queries, predefined templates, or system-generated suggestions. Technically, prompts are tokenized and embedded into the model's input sequence, serving as conditioning signals for subsequent text generation. Experiment with prompt variations can be performed to manipulate output, using techniques like prefixing, temperature control, top-K sampling, chain-of-thought, etc. These prompts, sourced from diverse inputs and tailored strategies, enable users to influence LLM-generated content by shaping the underlying context and guiding the neural network's language generation. For example, prompts can include instructions and/or examples to encourage the LLMs to provide results in a desired style and/or format.

### Example Architecture of LLM

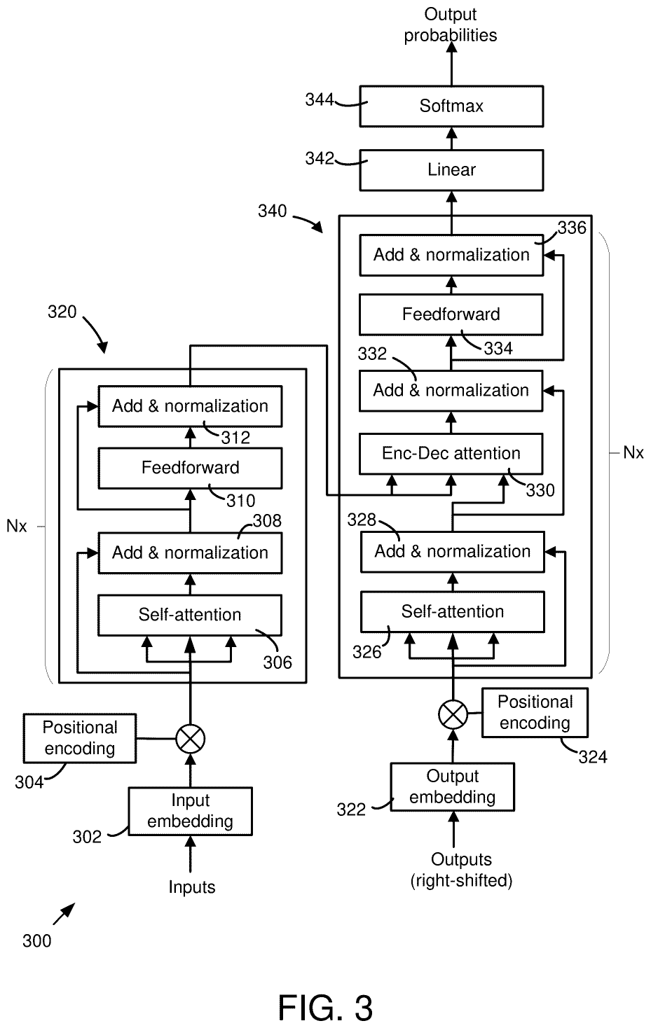

FIG. 3 shows an example architecture of an LLM 300, which can be used as the external generative AI model 132 and/or local generative AI model 144 of FIG. 1.

In the depicted example, the LLM 300 uses an autoregressive model (as implemented in OpenAI's GPT) to generate text content by predicting the next word in a sequence given the previous words. The LLM 300 can be trained to maximize the likelihood of each word in the training dataset, given its context.

As shown in FIG. 3, the LLM 300 can have an encoder 320 and a decoder 340, the combination of which can be referred to as a “transformer.” The encoder 320 processes input text, transforming it into a context-rich representation. The decoder 340 takes this representation and generates text output.

For autoregressive text generation, the LLM 300 generates text in order, and for each word it generates, it relies on the preceding words for context. During training, the target or output sequence, which the model is learning to generate, is presented to the decoder 340. However, the output is right shifted by one position compared to what the decoder 340 has generated so far. In other words, the model sees the context of the previous words and is tasked with predicting the next word. As a result, the LLM 300 can learn to generate text in a left-to-right manner, which is how language is typically constructed.

Text inputs to the encoder 320 can be preprocessed through an input embedding unit 302. Specifically, the input embedding unit 302 can tokenize a text input into a sequence of tokens, each of which represents a word or part of a word. Each token can then be mapped to a fixed-length vector known as an input embedding, which provides a continuous representation that captures the meaning and context of the text input. Likewise, to train the LLM 300, the targets or output sequences presented to the decoder 340 can be preprocessed through an output embedding unit 322. Like the input embedding unit 302, the output embedding unit 322 can provide a continuous representation, or output embedding, for each token in the output sequences.

Generally, the vocabulary in LLM 300 is fixed and is derived from the training data. The vocabulary in LLM 300 consists of tokens generated above during the training process. Words not in the vocabulary cannot be output. These tokens are strung together to form sentences in the text output.

In some examples, positional encodings (e.g., 304 and 324) can be performed to provide sequential order information of tokens generated by the input embedding unit 302 and output embedding unit 322, respectively. Positional encoding is needed because the transformer, unlike recurrent neural networks, process all tokens in parallel and do not inherently capture the order of tokens. Without positional encoding, the model would treat a sentence as a collection of words, losing the context provided by the order of words. Positional encoding can be performed by mapping each position/index in a sequence to a unique vector, which is then added to the corresponding vector of input embedding or output embedding. By adding positional encoding to the input embedding, the model can understand the relative positions of words in a sentence. Similarly, by adding positional encoding to the output encoding, the model can maintain the order of words when generating text output.

Each of the encoder 320 and decoder 340 can include multiple stacked or repeated layers (denoted by Nx in FIG. 3). The number of stacked layers in the encoder 320 and/or decoder 340 can vary depending on the specific LLM architecture. Generally, a higher “N” typically means a deeper model, which can capture more complex patterns and dependencies in the data but may require more computational resources for training and inference. In some examples, the number of stacked layers in the encoder 320 can be the same as the number of stacked layers in the decoder 340. In other examples, the LLM 300 can be configured so that the encoder 320 and decoder 340 can have different numbers of layers. For example, a deeper encoder (more layers) can be used to better capture the input text's complexities while a shallower decoder (fewer layers) can be used if the output generation task is less complex).

The encoder 320 and the decoder 340 are related through shared embeddings and attention mechanisms, which allow the decoder 340 to access the contextual information generated by the encoder 320, enabling the LLM 300 to generate coherent and contextually accurate responses. In other words, the output of the encoder 320 can serve as a foundation upon which the decoder network can build the generated text.

Both the encoder 320 and decoder 340 comprise multiple layers of attention and feedforward neural networks. An attention neural network can implement an “attention” mechanism by calculating the relevance or importance of different words or tokens within an input sequence to a given word or token in an output sequence, enabling the model to focus on contextually relevant information while generating text. In other words, the attention neural network plays “attention” on certain parts of a sentence that are most relevant to the task of generating text output. A feedforward neural network can process and transform the information captured by the attention mechanism, applying non-linear transformations to the contextual embeddings of tokens, enabling the model to learn complex relationships in the data and generate more contextually accurate and expressive text.

In the example depicted in FIG. 3, the encoder 320 includes an intra-attention or self-attention neural network 306 and a feedforward neural network 310, and the decoder 340 includes a self-attention neural network 326 and a feedforward neural network 334. The self-attention neural networks 306, 326 allow the LLM 300 to weigh the importance of different words or tokens within the same input sequence (self-attention in the encoder 320) and between the input and output sequences (self-attention in the decoder 340), respectively.

In addition, the decoder 340 also includes an inter-attention or encoder-decoder attention neural network 330, which receives input from the output of the encoder 320. The encoder-decoder attention neural network 330 allows the decoder 340 to focus on relevant parts of the input sequence (output of the encoder 320) while generating the output sequence. As described below, the output of the encoder 320 is a continuous representation or embedding of the input sequence. By feeding the output of the encoder 320 to the encoder-decoder attention neural network 330, the contextual information and relationships captured in the input sequence (by the encoder 320) can be carried to the decoder 340. Such connection enables the decoder 340 to access to the entire input sequence, rather than just the last hidden state. Because the decoder 340 can attend to all words in the input sequence, the input information can be aligned with the generation of output to improve contextual accuracy of the generated text output.

In some examples, one or more of the attention neural networks (e.g., 306, 326, 330) can be configured to implement a single head attention mechanism, by which the model can capture relationships between words in an input sequence by assigning attention weights to each word based on its relevance to a target word. The term “single head” indicates that there is only one set of attention weights or one mechanism for capturing relationships between words in the input sequence. In some examples, one or more of the attention neural networks (e.g., 306, 326, 330) can be configured to implement a multi-head attention mechanism, by which multiple sets of attention weights, or “heads,” in parallel to capture different aspects of the input sequence. Each head learns distinct relationships and dependencies within the input sequence. These multiple attention heads can enhance the model's ability to attend to various features and patterns, enabling it to understand complex, multi-faceted contexts, thereby leading to more accurate and contextually relevant text generation. The outputs from multiple heads can be concatenated or linearly combined to produce a final attention output.

As depicted in FIG. 3, both the encoder 320 and the decoder 340 can include one or more addition and normalization layers (e.g., the layers 308 and 312 in the encoder 320, the layers 328, 332, and 336 in the decoder 340). The addition layer, also known as a residual connection, can add the output of another layer (e.g., an attention neural network or a feedforward network) to its input. After the addition operation, a normalization operation can be performed by a corresponding normalization layer, which normalizes the features (e.g., making the features to have zero mean and unit variance), This can help in stabilizing the learning process and reducing training time.

A linear layer 342 at the output end of the decoder 340 can transform the output embeddings into the original input space. Specifically, the output embeddings produced by the decoder 340 are forwarded to the linear layer 342, which can transform the high-dimensional output embeddings into a space where each dimension corresponds to a word in the vocabulary of the LLM 300.

The output of the linear layer 342 can be fed to a softmax layer 344, which is configured to implement a softmax function, also known as softargmax or normalized exponential function, which is a generalization of the logistic function that compresses values into a given range. Specifically, the softmax layer 344 takes the output from the linear layer 342 (also known as logits) and transforms them into probabilities. These probabilities sum up to 1, and each probability corresponds to the likelihood of a particular word being the next word in the sequence. Typically, the word with the highest probability can be selected as the next word in the generated text output.

Still referring to FIG. 3, the general operation process for the LLM 300 to generate a reply or text output in response to a received prompt input is described below.

First, the input text is tokenized, e.g., by the input embedding unit 302, into a sequence of tokens, each representing a word or part of a word. Each token is then mapped to a fixed-length vector or input embedding. Then, positional encoding 304 is added to the input embeddings to retain information regarding the order of words in the input text.

Next, the input embeddings are processed by the self-attention neural network 306 of the encoder 320 to generate a set of hidden states. As described above, multi-head attention mechanism can be used to focus on different parts of the input sequence. The output from the self-attention neural network 306 is added to its input (residual connection) and then normalized at the addition and normalization layer 308.

Then, the feedforward neural network 310 is applied to each token independently. The feedforward neural network 310 includes fully connected layers with non-linear activation functions, allowing the model to capture complex interactions between tokens. The output from the feedforward neural network 310 is added its input (residual connection) and then normalized at the addition and normalization layer 312.

The decoder 340 uses the hidden states from the encoder 320 and its own previous output sequence to generate the next token in an autoregressive manner so that the sequential output is generated by attending to the previously generated tokens. Specifically, the output of the encoder 320 (input embeddings processed by the encoder 320) are fed to the encoder-decoder attention neural network 330 of the decoder 340, which allows the decoder 340 to attend to all words in the input sequence. As described above, the encoder-decoder attention neural network 330 can implement a multi-head attention mechanism, e.g., computing a weighted sum of all the encoded input vectors, with the most relevant vectors being attributed the highest weights.

The previous output sequence of the decoder 340 is first tokenized by the output embedding unit 322 to generate an output embedding for each token in the output sequence. Similarly, positional embedding 324 is added to the output embedding to retain information regarding the order of words in the output sequence.

The output embeddings are processed by the self-attention neural network 326 of the decoder 340 to generate a set of hidden states. The self-attention mechanism allows each token in the text output to attend to all tokens in the input sequence as well as all previous tokens in the output sequence. The output from the self-attention neural network 326 is added to its input (residual connection) and then normalized at the addition and normalization layer 328.

The encoder-decoder attention neural network 330 receives the output embeddings processed through the self-attention neural network 326 and the addition and normalization layer 328. Additionally, the encoder-decoder attention neural network 330 also receives the output from the addition and normalization layer 312 which represents input embeddings processed by the encoder 320. By considering both processed input embeddings and output embeddings, the output of the encoder-decoder attention neural network 330 represents an output embedding which takes into account both the input sequence and the previously generated outputs. As a result, the decoder 340 can generate the output sequence that is contextually aligned with the input sequence.

The output from the encoder-decoder attention neural network 330 is added to part of its input (residual connection), i.e., the output from the addition and normalization layer 328, and then normalized at the addition and normalization layer 332. The normalized output from the addition and normalization layer 332 is then passed through the feedforward neural network 334. The output of the feedforward neural network 334 is then added to its input (residual connection) and then normalized at the addition and normalization layer 336.

The processed output embeddings output by the decoder 340 are passed through the linear layer 342, which maps the high-dimensional output embeddings back to the size of the vocabulary, that is, it transforms the output embeddings into a space where each dimension corresponds to a word in the vocabulary. The softmax layer 344 then converts output of the linear layer 342 into probabilities, each of which corresponds to the likelihood of a particular word being the next word in the sequence. Finally, the LLM 300 samples an output token from the probability distribution generated by the softmax layer 344 (e.g., selecting the token with the highest probability), and this token is added to the sequence of generated tokens for the text output.

The steps described above are repeated for each new token until an end-of-sequence token is generated or a maximum length is reached. Additionally, if the encoder 320 and/or decoder 340 have multiple stacked layers, the steps performed by the encoder 320 and decoder 340 are repeated across each layer in the encoder 320 and the decoder 340 for generation of each new token.

### Example Overall Method for Improved Generative AI Support in ERP Systems

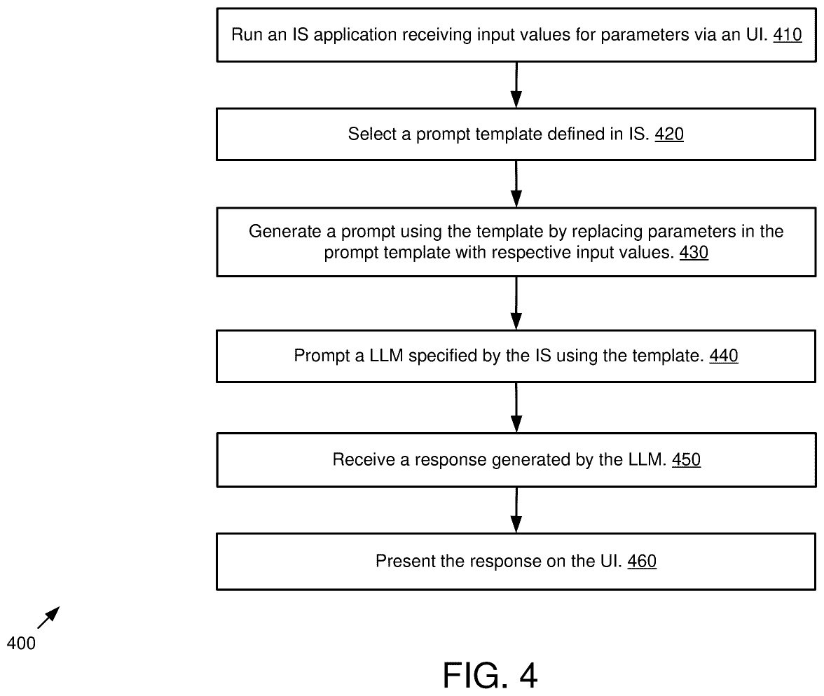

FIG. 4 is a flowchart illustrating an example overall method 400 for improved generative AI support in ERP systems. The method 400 can be performed, e.g., by the computing system 100 of FIG. 1.

At step 410, a tenant user can run an application (e.g., the generative AI application 112) associated with an intelligent scenario deployed on an ERP system. The application can be configured to receive input values for one or more parameters from the tenant user through a user interface (e.g., buttons, textboxes, dropdown menus, checkboxes, radio buttons, sliders, date pickers, etc.) of the ERP system.

At step 420, a prompt template defined in the intelligent scenario can be selected automatically in runtime. The prompt template can be retrieved from a data storage (e.g., the data storage 122) and include the one or more parameters configured to receive input values from the user. In some examples, domain context for the input values can be obtained (e.g., by the domain context handler 126), in runtime, from a database of the ERP system that is specific to the tenant user. The domain context can include metadata of the one or more parameters. For example, the metadata can include descriptions, examples, and/or other information pertinent to the one or more parameters.

At step 430, a prompt can be generated (e.g., by the prompt generator 124) using the prompt template. For instance, the prompt can be generated by replacing the one or more parameters in the prompt template with respective input values entered by the user.

At step 440, the prompt can be submitted (e.g., by the prompt handler 128), in runtime, to an LLM specified by the intelligent scenario. In some examples, the previously retrieved domain context can also be sent to the LLM along with the prompt. In some examples, at least some of the parameter values can be anonymized, in runtime, prior to prompting the LLM. For instance, sensitive parameter values (e.g., personal information, business-critical information, etc.) could be replaced with unique, non-sensitive tokens. A map or lookup table can be created in the ERP system to link the unique, non-sensitive tokens to the corresponding sensitive parameter values. In some examples, the prompt can be one of a plurality of prompts generated in runtime of the application, and the plurality of prompts can be ordered in a prompt chain for sequentially prompting the LLM.

At step 450, a response generated by the LLM can be received. In some examples, the response can be deanonymized in runtime, for example, by replacing unique, non-sensitive tokens present in the response with corresponding sensitive parameters (e.g., by checking the map or lookup table created in the ERP system when anonymizing the prompt).

At step 460, the response can be presented on the user interface of the ERP system.

The method 400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Operation Sequence of Running a Generative AI Application

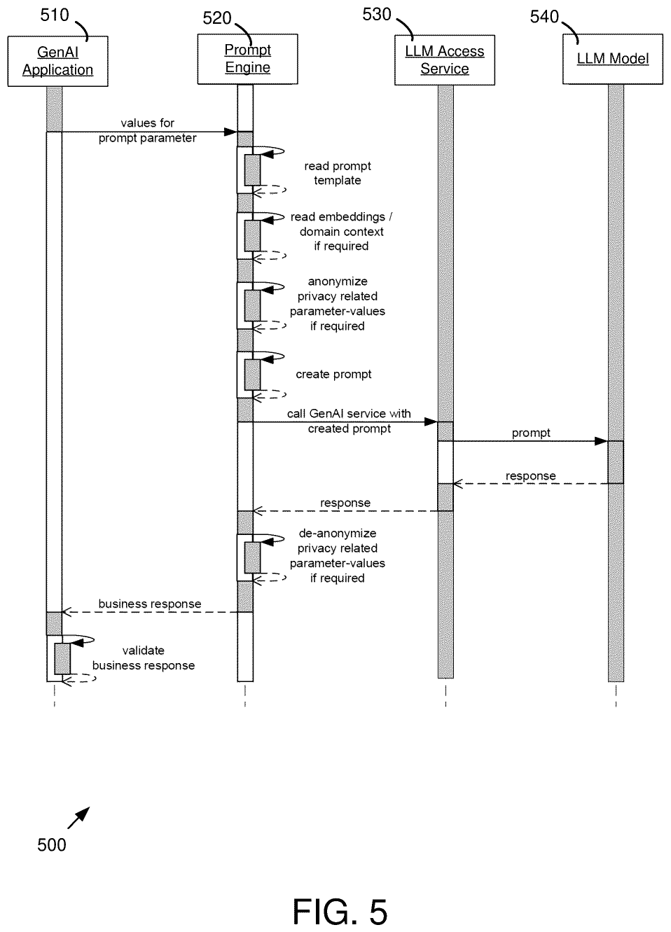

As described above, after deployment on an ERP system, a generative AI scenario can be activated and ready for inference consumption. FIG. 5 is a sequence diagram 500 illustrating the runtime behavior of a generative AI application 510 (similar to the generative AI application 112) embedded in an ERP system.

The generative AI application 510, which consumes a specific generative AI scenario, can receive input values for parameters included in a prompt template predefined for the generative AI scenario. These input values are sent to a prompt engine 520 (similar to the prompt engine 120), which can create a prompt by replacing parameters in the prompt template with user-provided input values. In certain cases, the prompt engine 520 can retrieve domain context for these input values, such as metadata of the template parameters, or access embeddings from a vector database (e.g., the vector database 156) to gain domain-specific knowledge. If any parameter values contain sensitive information, they can be anonymized during prompt creation. The prompt engine 520 can then invoke a method call embedded in the generative AI scenario, to request a generative AI service. This method call sends the prompt to an LLM access service layer 530 (similar to the access service layer 142), which forwards the prompt to a specified LLM model 540 (which can be hosted on a third-party platform or the organization's own cloud service platform). The response generated by the LLM model 540 is returned to the LLM access service layer 530, which sends it back to the prompt engine 520. If the original prompt was anonymized, the prompt engine 520 can deanonymize any anonymized values in the response. Finally, the response is returned to the generative AI application 510, where it undergoes validation (e.g., for security vulnerabilities or syntax correctness, etc.) before being presented to the user. For instance, if the generative AI application is used for code generation, the validation could include checking for SQL injections or syntax errors in the generated code.

### Example Prompt Templates and Configuration

As described above, prompt templates can be created during design time of a generative AI scenario for a specific use case, and parameters in the prompt templates can be replaced with concert values (e.g., provided by user's input) during runtime of the generative AI scenario. Each AI scenario can be consumed by a specific application.

For example, the following prompt template can be created for an application associated with a generative AI scenario for creating a sales order.
Generate a description for a sales order request with details [id], [date], to the supplier with details [name], [city], [country], in language [language], within [$.islm.this.limit] characters.

The above prompt template, which contains parameters in square brackets, can be defined and stored (e.g., in data storage 122) during design time. Storing these prompt templates in ERP systems can simply lifecycle management of the intelligent AI scenario, such as managing version dependencies of the prompt templates. Running the generative AI application can provide the values for these parameters at runtime. For example, a prompt generated in runtime based on the above prompt template can be as follows:
Generate a description for a sales order request with details sales order id=0001, with date 23.09.2023 to the supplier with details GIS Test, Bengaluru, India, in language English, within 200 characters.

As another example, the following prompt template can be created for another application associated with a different generative AI scenario for creating an internal job description.
You are an assistant designed to generate appealing job descriptions for an international company named [company_name]. Users will input structured data for a job position. You should generate an html-formatted job description.—Avoid bias based on physical appearance, ethnicity, or race. Replace inappropriate language with inclusive language, politely refuse results, if that is not possible.—Provide the response in [language].—Generate an internal job description for [job title]. The candidate shall have [Skill-01], [Skill-02] and [Skill-03].-The hiring Manager is [manager] and the recruiter is [recruiter].—Location is [location] and start of work is [start-date].

An example prompt generated in runtime based on the above prompt template can be as follows:
You are an assistant designed to generate appealing job descriptions for an international company named SAP SE Users will input structured data for a job position. You should generate an html-formatted job description.—Avoid bias based on physical appearance, ethnicity, or race. Replace inappropriate language with inclusive language, politely refuse results, if that is not possible.—Provide the response in English.—Generate an internal job description for Sales Manager. The candidate shall have Bachelor degree, analytical skills and ERP knowledge.—The hiring Manager is Mr. Smith and the recruiter is Ms. Miller.—Location is Germany and start of work is Jan. 1, 2024.

Depending on the use case, additional context may be appended to the created prompt or sent to the LLM along with the prompt. This can be just examples (e.g., for good job descriptions) which can be part of domain context (e.g., obtained by the domain context handler 126) in case of dynamic prompting. More complex context may be needed for more advanced prompting (e.g., PDF documents containing job descriptions for different job categories). For example, additional context containing domain-specific knowledge can be obtained from embeddings (e.g., stored in the vector database 156 and searchable by the embedding engine 154), as described above.

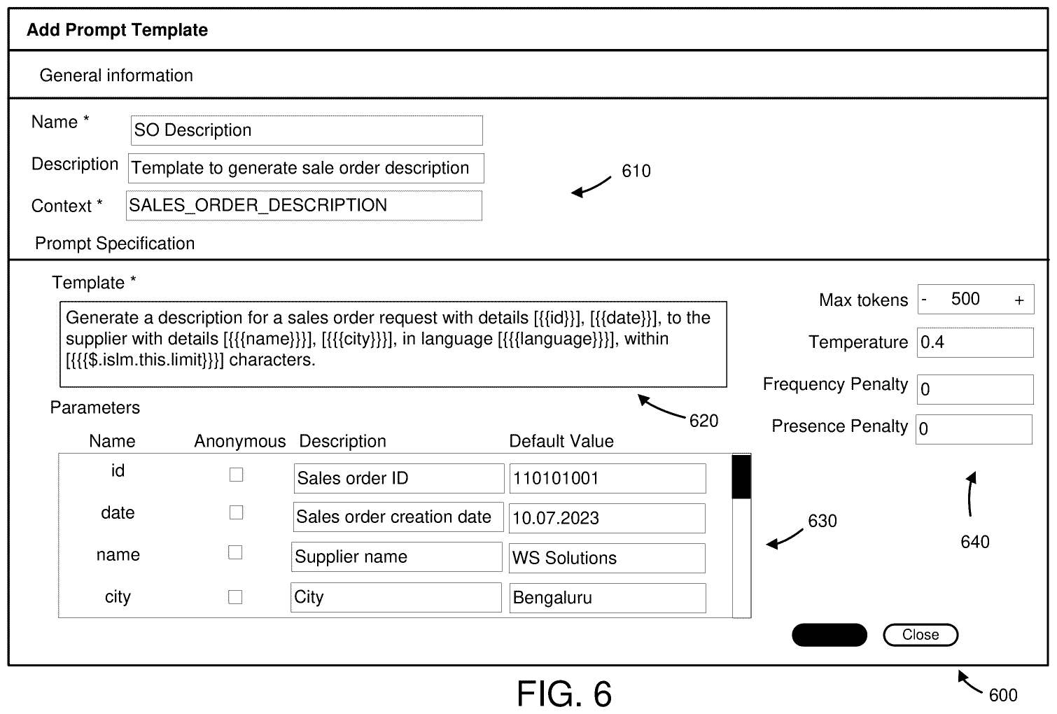

FIG. 6 illustrates an example user interface 600 that allows a developer or designer of generative AI scenarios to create prompt templates. The user interface 600 features a section 610 for specifying general information (e.g., name, description, context) about the prompt template. The user interface 600 also includes a textbox 620 for entering the prompt template. As depicted, the prompt template can incorporate several parameters enclosed in brackets. Domain context information for the parameters (e.g., name, description, default value, etc.) can be displayed in another section 630. For each parameter, a checkbox can be provided to indicate whether the value associated with the parameter contains sensitive information, which should be anonymized when submitting the prompt to the generative AI model. Additionally, the user interface 600 enables the configuration of certain prompt execution parameters 640, which can influence how the generative AI model executes the received prompt. For instance, the prompt execution parameters 640 can include max tokens (the maximum length of the generated text), temperature (controls the randomness of predictions), frequency penalty (penalizes new tokens based on their frequency), presence penalty (penalizes new tokens based on their presence), etc.

### Example Generative AI Scenario

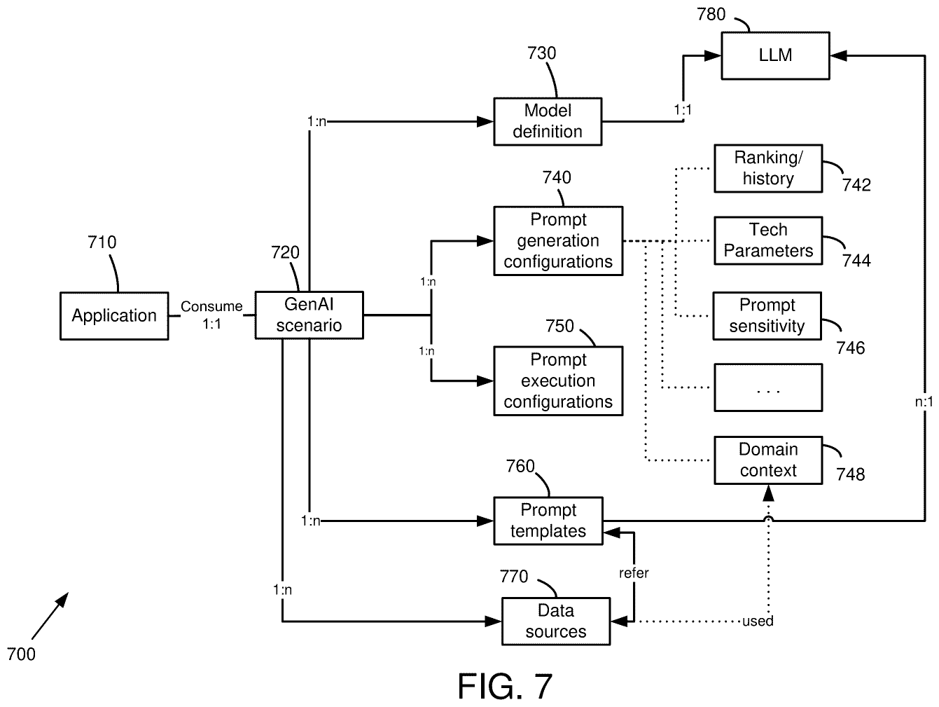

As described above, a generative AI scenario is an object encapsulating all relevant artifacts and metadata associated with a generative AI application. FIG. 7 depicts an example metamodel 700 of a generative AI scenario.

As shown, each generative AI scenario 720 can be consumed by a specific generative AI application 710 designed for a specific AI driven use case. The generative AI scenario 720 can have multiple model definitions 730, each model definition representing a specific LLM 780. Different versions of an LLM (e.g., ChatGPT 3.5 and ChatGPT 4.0) can be deemed as different model definitions. Each model definition 730 can define an interface with the corresponding LLM 780. This interface can be defined through an application programming interface (API) of the LLM 780. For instance, the model definition 730 can incorporate a method which is configured to dispatch a prompt, accompanied by specific parameters, to the LLM 780. Additionally, the model definition 730 can include another method which is configured to retrieve the response that is generated by the LLM 780.

Each generative AI scenario 720 can include a plurality of prompt templates 760. Each prompt template can include one or more parameters which are placeholders, designed to be replaced with actual values during execution of the generative AI application 710. For example, in runtime, a prompt template 760 can be used to generate a prompt by replacing the parameters with input values received by the generative AI application 710. The prompt can be sent to the LLM 780 to obtain a response, e.g., by calling the methods included in the model definition 730. In some examples, multiple prompt templates can be created for different LLMs 780 (provided by different vendors and/or the same vendor but with different versions). In some examples, multiple prompt templates can be used to create multiple prompts which can be ordered in a prompt chain for prompting the LLM 780 sequentially.

As shown, each generative AI scenario 720 can include a plurality of prompt generation configurations 740 and a plurality of prompt execution configurations 750. The prompt generation configurations 740 can include configuration parameters for generating the prompts, such as technical information 744 (e.g., ID, data type, etc.) of the parameters in the prompt templates, prompt sensitivity 746 (e.g., whether certain prompt parameters need to be anonymized or not), ranking/history parameters 742 (e.g., controlling how the prompts should be ordered in a prompt train, whether or not to save prompt history), etc. In some examples, the prompt generation configuration can also include domain context 748 retrieved from a data source 770 (e.g., references to specific data tables in a tenant specific database of the ERP system) defined in the generative AI scenario 720. The prompt execution configurations 750 can include configuration parameters for the LLM 780 to process or execute the prompts. Example prompt execution parameters include max tokens, temperature frequency penalty, presence penalty, etc.

In sum, each generative AI scenario is a comprehensive, standalone object that encapsulates all the necessary software artifacts and metadata required for a specific generative AI application. Thus, the metamodel 700 provides a robust and flexible framework for deploying generative AI applications across various use cases.

### Example Shared LLM Access Service

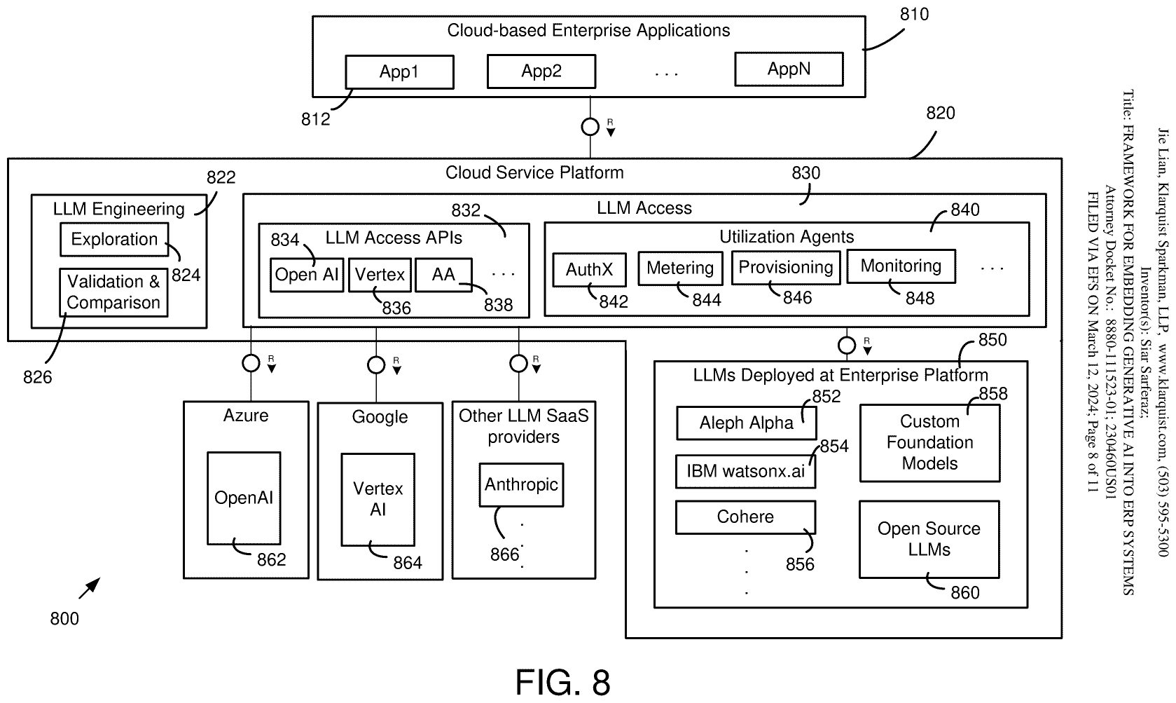

FIG. 8 is a block diagram depicting an example system architecture 800 supporting shared LLM access service for an ERP system.

As shown in FIG. 8, cloud-based enterprise applications 810, which can include a number of applications 812 (e.g., enterprise ERP application, etc.) can communicate with a cloud service platform 820 (similar to the cloud service platform 140). The cloud service platform 820 can include an LLM engineering toolbox 822, an LLM access layer 830, and one or more locally deployed LLMs 850. Examples of locally deployed LLMs 850 include Aleph Alpha Luminous 852, IBM watsonx.ai 854, Cohere AI 856, custom foundation models 858, and other open source LLMs 860. The LLM engineering toolbox 822 can include an exploration tool 824 configured to support prompt engineering for different LLMs, and a validation and comparison tool 826 configured to perform validation and comparison of performance of different LLMs. Similar to the LLM access service layer 530 and the access service layer 142, the LLM access layer 830 is configured to enable applications 812 to access different LLMs, including both locally deployed LLMs 850 and LLMs hosted externally by third parties. Examples of external LLMs include OpenAI 862 provided by Microsoft Azure, Vertex AI 864 provided by Google, and Anthropic 866 or other LLMs provided by other software-as-a-service (SaaS) providers.

The LLM access layer 830 includes a plurality of LLM access APIs 832, each of which corresponds to a supported LLM. For example, FIG. 8 shows that the LLM access layer 830 includes APIs 834, 836, and 838 for accessing OpenAI 862, Vertex AI 864, and Anthropic 866 models, respectively. Additionally, the LLM access layer 830 can include utilization agents 840 configured for a variety of functions pertinent to consumption of the LLM models. For example, an authorization agent 842 can be configured to authenticate user access to the LLMs; a metering agent 844 can be configured to measure and manage the resource usage of the LLMs; a provisioning agent 846 can be configured to handle the deployment of applications 812; a monitoring agent 848 can be configured to monitor the performance of the LLMs; and so on.

### Example Prompt Lifecycle Management

As described above, the ISLM framework can be used to perform lifecycle management of intelligent scenarios, including a generative AI scenario. Specifically, a prompt lifecycle manager within the ISLM framework can be configured to perform prompt lifecycle management for a generative AI scenario.

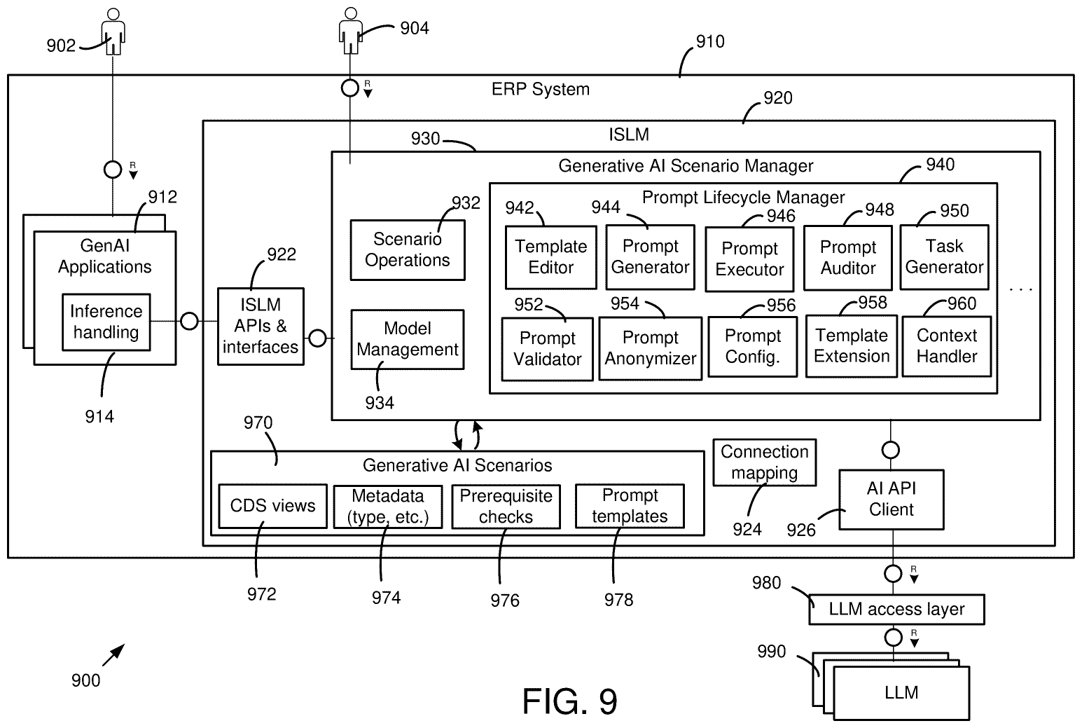

FIG. 9 is a block diagram depicting an example system architecture 900 supporting prompt lifecycle management. In the depicted example, an ERP system 910 has one or more generative AI applications 912 associated with corresponding generative AI scenarios 970 defined in an ISLM framework 920. Each generative AI scenario 970 can be managed by a generative AI scenario manager 930 included in the ISLM framework 920. The generative AI scenario manager 930, in conjunction with a generative AI scenario 970, can constitute the prompt engine 120 of FIG. 1. A tenant user 902 can launch and interact with the generative AI applications 912, e.g., entering input values for template parameters. An administrator 904 of the ERP system can interact with and change settings of the ISLM framework 920.

The ERP system 910 can be connected to one or more LLMs 990 through an LLM access layer 980 (similar to the LLM access layer 830 of FIG. 8). Such connection can be established through a client API portal 926. Additionally, a connection mapping unit 924 can be configured to map each generative AI application 912 to a target LLM 990 specified in the corresponding generative AI scenario 970.

Each generative AI application 912 has an inference handling unit 914 configured to send input to the target LLM 990 and process predictions or responses generated by the LLM 990. The ISLM framework 920 includes ISLM APIs and interfaces 922 through which the generative AI applications 912 can consume corresponding generative AI scenarios 970. Each generative AI scenario 970 can include one or more predefined prompt templates 978 and metadata 974, as described above. In some examples, a generative AI scenario 970 can also include views 972 which can be used to for retraining or fine-tuning of the target LLM 990. For example, core data service (CDS) views created in SAP S/4HANA can be used to define structured data models that combine data from various sources (e.g., database tables, other CDS views, and external sources). In some examples, a generative AI scenario 970 can further include a prerequisite check unit 976, which can be configured to automatically evaluate whether the generative AI scenario 970 is eligible for deployment or whether it can be activated after deployment. Exemplary prerequisite checks can include, e.g., checking if the quality and/or quantity of the application data are suitable for training of fine-tuning the target LLM 990, etc.

The generative AI scenario manager 930 can include a scenario operations unit 932, a model management unit 934, and a prompt lifecycle manager 940. The scenario operations unit 932 can be configured to automate AI model training and deployment and ensure seamless transition from prototyping to production. The model management unit 934 can be configured to oversee the storage of AI models in an internal repository, monitor model performance, and support retraining of the AI models.

The prompt lifecycle manager 940 is configured to manage the full lifecycle of any prompts or prompt templates associated with each generative AI scenario 970. The prompt lifecycle manager 940 can include a multitude of components configured for different functions. Example components include a template editor 942, a prompt generator 944, a prompt executor 946, a prompt auditor 948, a task generator 950, a prompt validator 952, a prompt anonymizer 954, a prompt configuration unit 956, a template extension 958, a context handler 960, etc. For example, the template editor 942 can provide capabilities for the creation and modification of prompt templates 978. The prompt generator 944 (similar to the prompt generator 124 of FIG. 1) can be configured generate prompts based on the prompt templates 978. The prompt executor 946 can be responsible for running the generated prompts and managing their execution (e.g., submitting the prompts to the LLM and receive response from the LLM). The prompt auditor 948 can be responsible for auditing the generated prompts for security compliance. The task generator 950 can be configured to generate tasks based on the prompts and their execution results (e.g., sequencing the prompts into a prompt train). The prompt validator 952 can be configured to validate the generated prompts to ensure they meet certain criteria. The prompt anonymizer 954 can be configured to anonymize the prompts to prevent sending sensitive data to external LLMs. The prompt configuration unit 956 can be used to change prompt execution parameters of the LLM. The template extension 958 can be used to extend the prompt templates with additional parameters and/or configuration parameters. The context handler 960 (like the context handler 126 of FIG. 1) can be configured to extract context information for the prompt templates 978. Some of the components can be combined. For example, the prompt anonymizer 954, in conjunction with the prompt executor 946 can constitute the prompt handler 128 of FIG. 1. Some of the components depicted above may be optional. In some cases, additional components can be included in the prompt lifecycle manager 940.

### Example Advantages

The technologies described herein introduces a new framework for integrating generative AI into ERP systems. One advantageous feature of this framework is the ability to handle tasks of varying complexity, from simple question-and-answer use cases managed by a digital assistant to runtime dynamic prompt generation, and to more complex tasks that leverage embeddings for domain-specific knowledge.

One technical feature of this framework is its dynamic prompt template management. Within this framework, the prompt engine within the ERP system can generate prompts dynamically based on predefined templates. These templates, designed during the design phase, can be filled with concrete values provided by user input during runtime. This dynamic generation, along with the provision of domain context, enhances the relevance and accuracy of the model-generated responses.

The framework also introduces the concept of a generative AI scenario, which is a comprehensive, standalone object encapsulating all the necessary software artifacts and metadata required for a specific generative AI application. Each generative AI scenario can include one or more software artifacts configured to interact with a generative AI model. The lifecycle management of these scenarios is handled by the ISLM framework, overseeing various phases of including design, deployment, activation, consumption, monitoring, and expiration.

Furthermore, the framework provides a shared LLM access layer. This allows generative AI applications to access different LLMs, regardless of whether they are locally or externally hosted, or provided by different vendors or versions. This shared access layer enhances the adaptability and versatility of the generative AI applications within the ERP system.

In summary, the disclosed technology presents a transformative framework that standardizes the implementation of generative AI in ERP systems, replacing ad hoc practices with a uniform approach that enhances quality and user experience across applications. This framework simplifies lifecycle management of AI solutions and encapsulates diverse AI models via a shared access layer, fostering interoperability and flexibility. This not only streamlines the development process but also ensures effective and efficient utilization of generative AI in ERP systems.

### Example Computing Systems

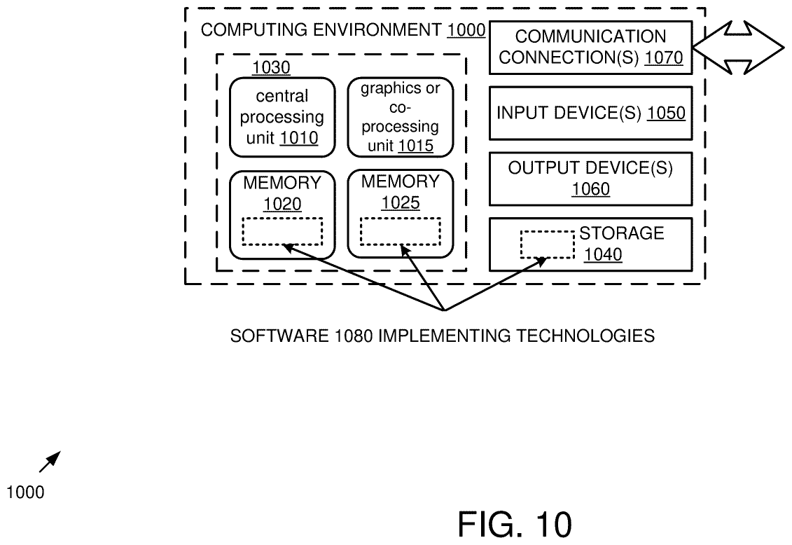

FIG. 10 depicts an example of a suitable computing system 1000 in which the described innovations can be implemented. The computing system 1000 is not intended to suggest any limitation as to scope of use or functionality of the present disclosure, as the innovations can be implemented in diverse computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 can execute computer-executable instructions, such as for implementing the features described in the examples herein (e.g., the method 400). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 10 shows a central processing unit 1010 as well as a graphics processing unit or co-processing unit 1015. The tangible memory 1020, 1025 can be volatile memory (e.g., registers, cache, RAM), non-volatile memory (e.g., ROM, EEPROM, flash memory, etc.), or some combination of the two, accessible by the processing unit(s) 1010, 1015. The memory 1020, 1025 can store software 1080 implementing one or more innovations described herein, in the form of computer-executable instructions suitable for execution by the processing unit(s) 1010, 1015.

A computing system 1000 can have additional features. For example, the computing system 1000 can include storage 1040, one or more input devices 1050, one or more output devices 1060, and one or more communication connections 1070, including input devices, output devices, and communication connections for interacting with a user. An interconnection mechanism (not shown) such as a bus, controller, or network can interconnect the components of the computing system 1000. Typically, operating system software (not shown) can provide an operating environment for other software executing in the computing system 1000, and coordinate activities of the components of the computing system 1000.

The tangible storage 1040 can be removable or non-removable, and includes magnetic disks, magnetic tapes or cassettes, CD-ROMs, DVDs, or any other medium which can be used to store information in a non-transitory way and which can be accessed within the computing system 1000. The storage 1040 can store instructions for the software implementing one or more innovations described herein.

The input device(s) 1050 can be an input device such as a keyboard, mouse, pen, or trackball, a voice input device, a scanning device, touch device (e.g., touchpad, display, or the like) or another device that provides input to the computing system 1000. The output device(s) 1060 can be a display, printer, speaker, CD-writer, or another device that provides output from the computing system 1000.

The communication connection(s) 1070 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

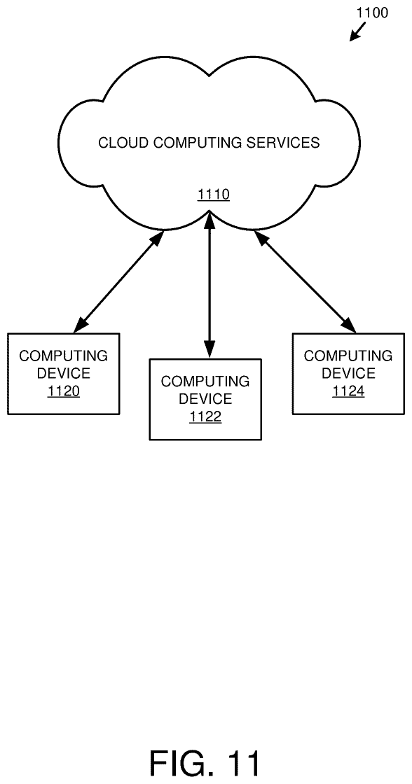

FIG. 11 depicts an example cloud computing environment 1100 in which the described technologies can be implemented, including, e.g., the system 100 and other systems herein. The cloud computing environment 1100 can include cloud computing services 1110. The cloud computing services 1110 can comprise various types of cloud computing resources, such as computer servers, data storage repositories, networking resources, etc. The cloud computing services 1110 can be centrally located (e.g., provided by a data center of a business or organization) or distributed (e.g., provided by various computing resources located at different locations, such as different data centers and/or located in different cities or countries).

The cloud computing services 1110 can be utilized by various types of computing devices (e.g., client computing devices), such as computing devices 1120, 1122, and 1124. For example, the computing devices (e.g., 1120, 1122, and 1124) can be computers (e.g., desktop or laptop computers), mobile devices (e.g., tablet computers or smart phones), or other types of computing devices. For example, the computing devices (e.g., 1120, 1122, and 1124) can utilize the cloud computing services 1110 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

In any of the examples described herein, an operation performed in runtime means that the operation can be completed in real time or with negligible processing latency (e.g., the operation can be completed within 1 second, etc.).

### Example Clauses

Any of the following example clauses can be implemented.
Clause 1. A computing system with improved generative artificial intelligence (AI) support for enterprise resource planning (ERP), the system comprising: memory; one or more hardware processors coupled to the memory; and one or more computer readable storage media storing instructions that, when loaded into the memory, cause the one or more hardware processors to perform operations comprising: running an application associated with an intelligent scenario deployed on an ERP system, wherein the application receives input values for one or more parameters from a tenant user through a user interface of the ERP system; selecting, in runtime, a prompt template defined in the intelligent scenario, wherein the prompt template includes the one or more parameters; generating, in runtime, a prompt using the prompt template, wherein generating the prompt comprises replacing the one or more parameters in the prompt template with respective input values; prompting, in runtime, a large language model (LLM) using the prompt, wherein the LLM is specified by the intelligent scenario; receiving a response generated by the LLM; and presenting the response on the user interface of the ERP system.
Clause 2. The computing system of clause 1, wherein the operations further comprise: anonymizing, in runtime, at least some of the input values prior to submitting the prompt to the LLM; and deanonymizing, in runtime, the response generated by the LLM.
Clause 3. The computing system of any one of clauses 1-2, wherein the LLM is selected from a plurality of LLMs, wherein the prompt template is selected from a plurality of prompt templates, wherein the plurality of prompt templates was created for the plurality of LLMs.
Clause 4. The computing system of any one of clauses 1-3, wherein the prompt is one of a plurality of prompts generated in runtime of the application, wherein the operations further comprise sequentially prompting the LLM using the plurality of prompts.
Clause 5. The computing system of any one of clauses 1-4, wherein the operations further comprise obtaining, in runtime, domain context for the input values, wherein the domain context comprises metadata of the one or more parameters, wherein the metadata defines the one or more parameters in a database of the ERP system that is specific to the tenant user.
Clause 6. The computing system of any one of clauses 1-5, wherein the operations further comprise creating the intelligent scenario, wherein creating the intelligent scenario comprises defining the prompt template.
Clause 7. The computing system of clause 6, wherein defining the prompt template comprises specifying the one or more parameters and retrieving metadata of the one or more parameters, wherein retrieving metadata comprises making one or more method calls on a database of the ERP system that is specific to the tenant user.
Clause 8. The computing system of clause 7, wherein defining the prompt template further comprises selecting at least some of the parameters for anonymization.
Clause 9. The computing system of any one of clauses 6-8, wherein creating the intelligent scenario further comprises selecting the LLM and specifying an interface between the intelligent scenario and the LLM.
Clause 10. The computing system of any one of clauses 6-9, wherein creating the intelligent scenario further comprises defining one or more execution parameters of LLM.
Clause 11. A computer-implemented method for improved generative artificial intelligence (AI) support for enterprise resource planning (ERP), the method comprising: running an application associated with an intelligent scenario deployed on an ERP system, wherein the application receives input values for one or more parameters from a tenant user through a user interface of the ERP system; selecting, in runtime, a prompt template defined in the intelligent scenario, wherein the prompt template includes the one or more parameters; generating, in runtime, a prompt using the prompt template, wherein generating the prompt comprises replacing the one or more parameters in the prompt template with respective input values; prompting, in runtime, a large language model (LLM) using the prompt, wherein the LLM is specified by the intelligent scenario; receiving a response generated by the LLM; and presenting the response on the user interface of the ERP system.
Clause 12. The computer-implemented method of clause 11, further comprising: anonymizing, in runtime, at least some of the input values prior to submitting the prompt to the LLM; and deanonymizing, in runtime, the response generated by the LLM.
Clause 13. The computer-implemented method of any one of clauses 11-12, wherein the LLM is selected from a plurality of LLMs, wherein the prompt template is selected from a plurality of prompt templates, wherein the plurality of prompt templates was created for the plurality of LLMs.
Clause 14. The computer-implemented method of any one of clauses 11-13, wherein the prompt is one of a plurality of prompts generated in runtime of the application, the method further comprising sequentially prompting the LLM using the plurality of prompts.
Clause 15. The computer-implemented method of clause 11, further comprising obtaining, in runtime, domain context for the input values, wherein the domain context comprises metadata of the one or more parameters, wherein the metadata defines the one or more parameters in a database of the ERP system that is specific to the tenant user.
Clause 16. The computer-implemented method of any one of clauses 11-15, further comprising creating the intelligent scenario, wherein creating the intelligent scenario comprises defining the prompt template.
Clause 17. The computer-implemented method of clause 16, wherein defining the prompt template comprises specifying the one or more parameters and retrieving metadata of the one or more parameters, wherein retrieving metadata comprises making one or more method calls on a database of the ERP system that is specific to the tenant user.
Clause 18. The computer-implemented method of any one of clauses 16-17, wherein creating the intelligent scenario further comprises selecting the LLM and specifying an interface between the intelligent scenario and the LLM.
Clause 19. The computer-implemented method of any one of clauses 16-18, wherein creating the intelligent scenario further comprises defining one or more execution parameters of LLM.
Clause 20. One or more non-transitory computer-readable media having encoded thereon computer-executable instructions causing one or more processors to perform a method for improved generative artificial intelligence (AI) support for enterprise resource planning (ERP), the method comprising: running an application associated with an intelligent scenario deployed on an ERP system, wherein the application receives input values for one or more parameters from a tenant user through a user interface of the ERP system; selecting, in runtime, a prompt template defined in the intelligent scenario, wherein the prompt template includes the one or more parameters; generating, in runtime, a prompt using the prompt template, wherein generating the prompt comprises replacing the one or more parameters in the prompt template with respective input values; prompting, in runtime, a large language model (LLM) using the prompt, wherein the LLM is specified by the intelligent scenario; receiving a response generated by the LLM; and presenting the response on the user interface of the ERP system.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system with improved generative artificial intelligence (AI) support for enterprise resource planning (ERP), the system comprising:
memory;
one or more hardware processors coupled to the memory; and
one or more computer readable storage media storing instructions that, when loaded into the memory, cause the one or more hardware processors to perform operations comprising:
running an application associated with an intelligent scenario deployed on an ERP system, wherein the application receives input values for one or more parameters from a tenant user through a user interface of the ERP system;
selecting, in runtime, a prompt template defined in the intelligent scenario, wherein the prompt template includes the one or more parameters;
generating, in runtime, a prompt using the prompt template, wherein generating the prompt comprises replacing the one or more parameters in the prompt template with respective input values;
prompting, in runtime, a large language model (LLM) using the prompt, wherein the LLM is specified by the intelligent scenario;
receiving a response generated by the LLM; and
presenting the response on the user interface of the ERP system.

2. The computing system of claim 1, wherein the operations further comprise:
anonymizing, in runtime, at least some of the input values prior to submitting the prompt to the LLM; and
deanonymizing, in runtime, the response generated by the LLM.

3. The computing system of claim 1, wherein the LLM is selected from a plurality of LLMs, wherein the prompt template is selected from a plurality of prompt templates, wherein the plurality of prompt templates was created for the plurality of LLMs.

4. The computing system of claim 1, wherein the prompt is one of a plurality of prompts generated in runtime of the application, wherein the operations further comprise sequentially prompting the LLM using the plurality of prompts.

5. The computing system of claim 1, wherein the operations further comprise obtaining, in runtime, domain context for the input values, wherein the domain context comprises metadata of the one or more parameters, wherein the metadata defines the one or more parameters in a database of the ERP system that is specific to the tenant user.

6. The computing system of claim 1, wherein the operations further comprise creating the intelligent scenario, wherein creating the intelligent scenario comprises defining the prompt template.

7. The computing system of claim 6, wherein defining the prompt template comprises specifying the one or more parameters and retrieving metadata of the one or more parameters, wherein retrieving metadata comprises making one or more method calls on a database of the ERP system that is specific to the tenant user.

8. The computing system of claim 7, wherein defining the prompt template further comprises selecting at least some of the parameters for anonymization.

9. The computing system of claim 6, wherein creating the intelligent scenario further comprises selecting the LLM and specifying an interface between the intelligent scenario and the LLM.

10. The computing system of claim 6, wherein creating the intelligent scenario further comprises defining one or more execution parameters of LLM.

11. A computer-implemented method for improved generative artificial intelligence (AI) support for enterprise resource planning (ERP), the method comprising:
running an application associated with an intelligent scenario deployed on an ERP system, wherein the application receives input values for one or more parameters from a tenant user through a user interface of the ERP system;
selecting, in runtime, a prompt template defined in the intelligent scenario, wherein the prompt template includes the one or more parameters;
generating, in runtime, a prompt using the prompt template, wherein generating the prompt comprises replacing the one or more parameters in the prompt template with respective input values;
prompting, in runtime, a large language model (LLM) using the prompt, wherein the LLM is specified by the intelligent scenario;
receiving a response generated by the LLM; and
presenting the response on the user interface of the ERP system.

12. The computer-implemented method of claim 11, further comprising:
anonymizing, in runtime, at least some of the input values prior to submitting the prompt to the LLM; and
deanonymizing, in runtime, the response generated by the LLM.

13. The computer-implemented method of claim 11, wherein the LLM is selected from a plurality of LLMs, wherein the prompt template is selected from a plurality of prompt templates, wherein the plurality of prompt templates was created for the plurality of LLMs.

14. The computer-implemented method of claim 11, wherein the prompt is one of a plurality of prompts generated in runtime of the application, the method further comprising sequentially prompting the LLM using the plurality of prompts.

15. The computer-implemented method of claim 11, further comprising obtaining, in runtime, domain context for the input values, wherein the domain context comprises metadata of the one or more parameters, wherein the metadata defines the one or more parameters in a database of the ERP system that is specific to the tenant user.

16. The computer-implemented method of claim 11, further comprising creating the intelligent scenario, wherein creating the intelligent scenario comprises defining the prompt template.

17. The computer-implemented method of claim 16, wherein defining the prompt template comprises specifying the one or more parameters and retrieving metadata of the one or more parameters, wherein retrieving metadata comprises making one or more method calls on a database of the ERP system that is specific to the tenant user.

18. The computer-implemented method of claim 16, wherein creating the intelligent scenario further comprises selecting the LLM and specifying an interface between the intelligent scenario and the LLM.

19. The computer-implemented method of claim 16, wherein creating the intelligent scenario further comprises defining one or more execution parameters of LLM.

20. One or more non-transitory computer-readable media having encoded thereon computer-executable instructions causing one or more processors to perform a method for improved generative artificial intelligence (AI) support for enterprise resource planning (ERP), the method comprising:
running an application associated with an intelligent scenario deployed on an ERP system, wherein the application receives input values for one or more parameters from a tenant user through a user interface of the ERP system;
selecting, in runtime, a prompt template defined in the intelligent scenario, wherein the prompt template includes the one or more parameters;
generating, in runtime, a prompt using the prompt template, wherein generating the prompt comprises replacing the one or more parameters in the prompt template with respective input values;
prompting, in runtime, a large language model (LLM) using the prompt, wherein the LLM is specified by the intelligent scenario;
receiving a response generated by the LLM; and
presenting the response on the user interface of the ERP system.
